(19) United States
(12) Patent Application Publication
(10) Pub. No.: US 2021/0197297 A1
(43) Pub. Date: Jul. 1, 2021

(54) TOOL HOLDER FOR A MACHINING TOOL WITH DEPTH-CONTROL STOP AND MACHINING DEVICE

(71) Applicant: Guehring KG, Albstadt (DE)

(72) Inventor: Felix REBHOLZ, Frohnstetten (DE)

(73) Assignee: Guehring KG, Albstadt (DE)

(21) Appl. No.: 17/078,683

(22) Filed: Oct. 23, 2020

Related U.S. Application Data
(63) Continuation of application No. PCT/DE2019/000121, filed on May 2, 2019.

(30) Foreign Application Priority Data
May 4, 2018 (DE) 10 2018 206 891.7

(51) Int. Cl. B23B 51/12; B23B 49/00

(52) U.S. Cl. CPC B23B 51/12; B23B 49/005

(57) ABSTRACT

The invention relates to a tool holder (2) for connecting a machining tool (4) having a depth-control stop (3) to a working spindle of a machine tool, having a spindle-side shaft part (6) and a receiving part (7) which supports the machining tool (4) and is connected in a rotationally fixed manner to the shaft part (6). The receiving part (7) is axially displaceable in the tool feed direction via a compression spring arrangement (21), that is supported on the shaft part (6), counter to a fixed stop (17a) on the shaft part (6) and can be displaced away from the fixed stop (17a) on the shaft part (6) during the impact of the depth stop (3) on a workpiece against the spring force of the compression spring device (21).

The invention relates to a tool holder for connecting a machining tool, in particular a countersinking tool, which carries a depth-control stop limiting the penetration depth into a workpiece, to a working spindle of a machine tool as well as a machining device.

Machining tools comprising a depth-control stop, which is arranged in a rotatable, yet axially fixed manner, for limiting the penetration depth of the machining tool into a workpiece, are known, for example, from DE 102014115768 B3, DE 102013013499 B3, DE 102008022968 A1, U.S. Pat. Nos. 2,477,891, 8,876,444 B1, or DE 202009017801 U1. To machine a workpiece, machining tools of this type are usually clamped into a tool holder, which is carried by a working spindle of a machine tool. When reaching a pre-defined machining depth, the depth-control stop, which is arranged at the machining tool, strikes against the workpiece surface, whereby a further penetration of the machining tool into the workpiece is prevented.

However, the depth-control stop of the machining tool, which strikes against the workpiece surface in an uncontrolled manner when reaching the defined machining depth, can leave unwanted chatter marks at the workpiece surface due to irregularities in the workpiece surface, due to axial position deviations between the workpiece surface and the support of the working spindle of a machine tool carrying the machining tool, or due to position accuracies in the tool or workpiece clamping. An uncontrolled striking of the depth-control stop against the workpiece surface and chatter marks at the workpiece surface resulting therefrom can in particular also appear when the machining is performed in a vibration-supported manner with the use of an axial vibration unit, as it is specified, e.g., in EP 2501518 B1. It is well known that a vibration-supported machining offers the advantage of an improved chip breaking, i.e. short chips, and thus an improved chip removal.

With this in mind, the invention is based on the object of creating a tool holder with a simple design, which can be produced cost-efficiently, for connecting a machining tool having a depth-control stop, in particular countersinking tool, to a working spindle of a machine tool, which prevents damages, such as, e.g., chatter marks, to the workpiece surface resulting from the depth-control stop.

This object is solved by means of a tool holder comprising the features of claim 1. Advantageous or preferred further developments are the subject matter of dependent claims. Claim 11 relates to a machining tool, consisting of a tool holder according to the invention, and a machining tool, which prevents damages, such as, e.g., chatter marks, at a workpiece surface resulting from a depth-control stop.

A tool holder according to the invention for connecting a rotationally drivable machining tool, which carries a depth-control stop, which is arranged in a rotatable, yet axially fixed manner, to a working spindle of a machine tool, has a spindle-side shaft part and a receiving part holding the machining tool. The receiving part is connected in a rotationally fixed manner to the shaft part.

The shaft part, which is preferably cylindrical, serves for the (indirect or direct) coupling of the tool holder to a drive spindle of a machine tool. In the usual way, the shaft part has, for this purpose, on its end section facing away from the receiving part, a suitable clamping shaft, which can be embodied, e.g., as hollow shaft cone (HSK), cylinder shaft, steep-angle taper (SK), or the like.

The receiving part serves for concentrically receiving, holding, and clamping the machining tool. This can take place in a non-positive manner, e.g. by means of a hydraulic expansion or shrinking mechanism, a collet mechanism, or a quick change mechanism. The receiving part can thus have a clamping mechanism in the manner of a hydraulic expansion chuck, shrink chuck, or quick change chuck known per se, or a collet chuck or cylinder shaft clamping mechanism likewise known per se.

According to the invention, the receiving part is axially biased against a fixed stop at the shaft part in the tool feed direction by means of a compression spring arrangement and can be displaced away from the fixed stop at the shaft part, i.e. in the direction of the shaft part when the depth-control stop impacts on a workpiece, i.e. during a machining of a workpiece, against the spring force of the compression spring arrangement. In other words, the receiving part is thus connected in a rotationally fixed manner to the shaft part, and in a movable manner opposite to the tool feed direction against a spring bias. The axial freedom of movement of the receiving part is thus limited by the fixed stop formed and the resilient stop by the compression spring arrangement. The spring bias provides for a length adjustment of the machining device consisting of the tool holder and the machining tool under pressure, but does not allow a length adjustment under tension. When reaching a machining depth specified by the depth-control stop, uncontrolled axial movements, for example vibrations in the tool feed direction, can thus be adjusted via the compression spring arrangement, whereby an excessive striking of the depth-control stop against the workpiece and thus the creation of chatter marks at the workpiece surface can be prevented.

The tool holder according to the invention is designed in particular for the connection of a countersinking tool carrying a depth-control stop to a work spindle of a machine tool, which is driven, for example, in a vibration-supported manner. The machining by means of countersinking is thus the main field of application of the machine tool according to the invention. However, the tool holder according to the invention can additionally also be used for machining processes, which take place in the tool feed direction, such as, e.g. machining by means of drilling or reaming, in the case of which the machining tool carries a depth-control stop for limiting the machining depth.

To set the spring force, the compression spring arrangement can be supported on an axially settable setting stop in the shaft part. The spring force setting can be accomplished relatively easily when the setting stop has a setting screw, which is screwed to the shaft part.

In this case, the setting screw can form a guide extension, which engages with an axial bore in the receiving part. The guide extension can then be used for axially guiding the receiving part relative to the shaft part and simultaneously for positioning the compression spring arrangement.

Even in the case of a vibration-supported machining, a compression spring arrangement formed from a disk spring assembly ensures a permanently table spring force application of the receiving part, which reliably withstands axial force impacts exerted on the receiving part.

In terms of a compact design of the tool holder, the receiving part can have a guide section engaging with an axial bore in the shaft part. The above-mentioned axial bore, with which the guide extension of the setting screw engages, can be formed in the guide section.

In a preferred embodiment, the receiving part has a cylindrical receiving section, which axially adjoins the guide section and which is designed for a non-positive clamping of a cylinder shaft of the machining tool.

A rotationally fixed connection between the receiving part and the shaft part can be accomplished easily via a driving pin, which protrudes diametrically from the guide section and which is guided in diametrically opposite elongated holes in the shaft part.

The shaft part can furthermore be formed from a cylindrical hollow body. The coupling to the drive spindle of a machine tool can then be accomplished relatively easily by means of a non-positive clamping of the shaft part. With the above-mentioned cylindrical receiving section, the tool holder can be formed cylindrically as a whole, i.e. over its entire length. The receiving section can thereby have an outer diameter, which is smaller than or equal to the outer diameter of the shaft part. A particularly compact tool holder, which can be handled easily, can be produced in this way.

With the machining tool, which is clamped in the receiving part and has a depth-control stop, the tool holder according to the invention forms a device, by means of which a machining can be performed, without leaving behind chatter marks at the machined workpiece.

An embodiment of a tool holder according to the invention as well as an embodiment of a machining tool according to the invention will be described below based on the enclosed drawings.

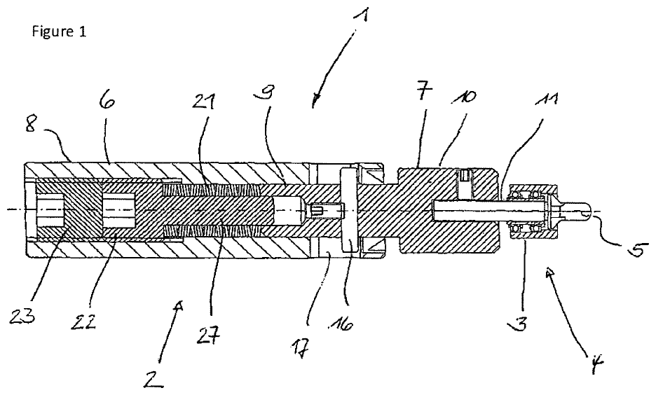

FIG. 1 shows an embodiment of a machining device according to the invention, which is formed from a tool holder according to the invention and a machining tool comprising a depth-control stop.

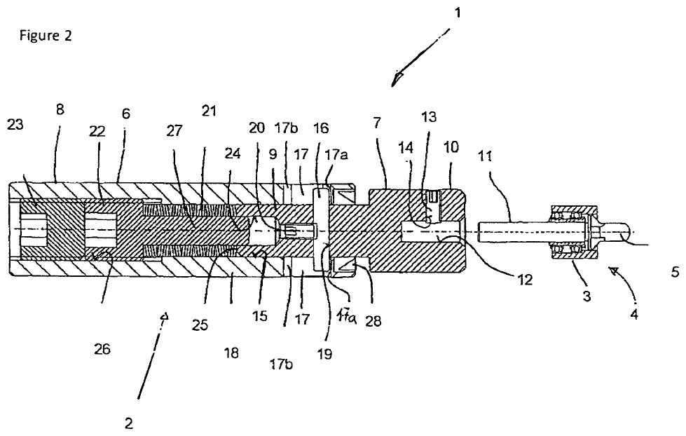

FIG. 2 shows the tool holder and the machining tool from FIG. 1 next to one another.

FIG. 1 shows in particular an axial section through an embodiment of a rotationally drivable machining tool 1 according to the invention, which consists of a tool holder 2 according to the invention and a machining tool 4, which is held by the tool holder 2 and which has a depth-control stop 3. The axis of rotation is specified with reference numeral 5. FIG. 2 shows the tool holder 2 and the machining tool 4 in the separated state. In the shown embodiment, the machining tool 4 is, for example, a reaming/countersinking tool.

The modularly designed tool holder 2 has a spindle-side shaft part 6 and a tool-side holding part 7.

The essentially cylindrical shaft part 6 serves for the (indirect or direct) coupling of the tool holder 2 to a drive spindle of a (non-illustrated) machine tool. In the shown embodiment, the shaft part 6, which is made of a cylindrical hollow body, has on its end section facing away from the receiving part 7, a cylindrical clamping shaft 8, which is to be clamped in a non-positive manner.

The receiving part 7 is connected in a rotationally fixed and axially displaceable manner to the shaft part 6. The receiving part 7 can be functionally divided into an essentially cylindrical guide section 9 and an essentially cylindrical receiving section 10, which has a larger diameter.

The receiving section 10 has the function of receiving the machining tool 4, which has the depth-control stop 3, as it is shown in the figures. As mentioned above, the design of a machining tool of this type is known, for example, in DE 102014115768 B3, DE 858487 A, DE 552110 C, or DE 202009017801 U1. The depth-control stop is arranged in an axially fixed, but rotationally movable manner at the machining tool 4, in the shown embodiment at a clamping shaft 11 of the machining tool 4, via a rotary bearing, in the shown embodiment a roller bearing. When reaching a pre-defined machining depth, the depth-control stop 3, which is arranged at the machining tool 4, thus strikes against the workpiece surface, whereby a further penetration of the machining tool 4 into the workpiece is prevented. In the shown embodiment, the fastening of the machining tool 4 in the receiving section 7 can be accomplished by means of a non-positive clamping of the cylindrical clamping shaft 11 in a centrical receiving bore 12 of the receiving section 10 by means of a clamping screw 13, which presses radially against the cylindrical clamping shaft 11 and which is screwed into a threaded bore 14 in the receiving section 10 so as to be capable of being actuated radially from the outside.

The guide section 9 has the function of connecting the receiving part 7 in a rotationally fixed manner (for a torque synchronization) and axially movable manner (for a length adjustment under tension) to the shaft part 6. For this purpose, the guide section 9 engages in an axially displaceable manner with an axial bore 15 in the shaft part 6. The rotationally fixed and axially movable connection of the receiving part 7 to the shaft part 6 can be accomplished by means of a driving pin 16, which is held at the guide section 9, protrudes diametrically, and is guided in diametrically opposite elongated holes 17 in a wall 18 surrounding the receiving bore 15 in the shaft part 6. As the figures show, the driving pin 16 is arranged in a cross bore 19, which passes through the guide section 9 and is fastened so as to be protected against loosening by means of a clamping screw 20, which presses against the driving pin 16. The clamping screw 20 can be actuated in a state prior to the installation of a compression spring arrangement 21, a setting screw 22, and a lock screw 23 into the shaft part 6 via an axial bore 24 in the guide section 9 of the receiving part 7.

The axial freedom of movement of the receiving part 7 in the tool feed direction, i.e. towards the machining tool 4, is limited when the driving pin 16 strikes against the tool-side ends 17a of the elongates holes in the shaft part 6. The elongated hole ends 17a thus form an axial stop according to the claims for the receiving part 7 at the shaft part 6. In the opposite direction, i.e. towards the shaft part 6, the axial freedom of movement of the receiving part 7 is limited by the mentioned compression spring arrangement 21. In the shown embodiment, the compression spring arrangement 21 is formed from a disk spring assembly. As it is shown in the figures, the compression spring arrangement 21 is supported in the tool feed direction at a front side 25 of the cylindrical guide section 9 of the receiving part 7.

The compression spring arrangement 21 is designed or can be set in such a way, respectively, that the driving pin 16 always strikes against the disk spring assembly 21, i.e. not against the shaft part-side or working spindle-side ends 17b, respectively, of the elongated holes 17 in the shaft part 6 towards the shaft part 6 or towards the working spindle, respectively. This is important in order to always still attain a desired axial resilience of the receiving part 7 with the machining tool 4, which holds the depth-control stop 3, when reaching the above-defined machining depth, at which the depth-control stop 3 strikes against the machined workpiece. This axial resilience provides for a length adjustment of the tool holder 2, which prevents chatter marks resulting from the depth-control stop 3, or the like at the machined workpiece. The spring bias of the receiving part 7 in the tool feed direction against a fixed axial stop 17a at the shaft part 7 is thus an essential feature of the invention. In the shown embodiment, the compression spring arrangement 21 formed from the disk spring assembly presses the receiving part 7 against the fixed axial stop formed by the axial ends 17a of the elongated holes 17 in the shaft part 7. When the depth-control stop 4 impacts on a workpiece, the receiving part 7 can then be displaced away from the fixed axial stop at the shaft part 7 against the spring force of the compression spring arrangement 21. The compression spring bias of the receiving part 7 against the fixed stop 17a at the shaft part 6 thus provides for the desired length adjustment under pressure, but does not allow a length adjustment under tension.

In the shown embodiment, the compression spring arrangement is supported on a setting screw 22, which is screwed into a threaded bore 26, in a direction opposite to the tool feed direction. The threaded bore adjoins the above-mentioned axial bore 15 of the shaft part 6. The setting screw 22, which is protected against loosening by means of the lock screw 23, forms an axially settable setting stop according to the claims, which provides for a setting of the spring bias. As the figures show, the setting screw 22 has a cylindrical guide extension 27, which engages with the axial bore 24 in the cylindrical guide section 9 of the receiving part 7. The compression spring arrangement 21 sits on the guide extension 27 of the setting screw 22.

The figures furthermore show that the receiving section 10 of the receiving part 7 has a slightly smaller outer diameter than the shaft part 6. For the sake of a simple handling, the tool holder 2 can thus be designed to be as compact as possible. Deviating from this, the receiving section 10 of the receiving part 7 and the shaft part 6 can have an essentially identical outer diameter, i.e. the tool holder 2 as a whole can be embodied to be essentially cylindrical.

Reference numeral 28 shows a shaft sealing ring, which is to prevent the penetration of dirt or the escape of grease, respectively.

The tool holder 2 shown in the figures is designed specifically for the connection of a countersinking tool 4 carrying a depth-control stop 3 to a working spindle of a machine tool. The machining of a workpiece by means of countersinking is thus the main field of application of the tool holder shown in the figures. However, the tool holder 2 according to the invention can additionally generally also be used for machining processes, in particular machining by means of drilling or reaming, which take place in the tool feed direction, in the case of which the machining tool carries a depth-control stop for limiting the machining depth.

With the machining tool 4, which is clamped in the receiving part 7 and which has a depth-control stop 3, the tool holder 2 according to the invention forms a machining device 1, by means of which a machining can be performed without leaving chatter marks at the machined workpiece.

1. A tool holder for connecting a machining tool having a depth-control stop to a working spindle of a machine tool, comprising a spindle-side shaft part and a receiving part, which holds the machining tool and which is connected in a rotationally fixed manner to the shaft part, wherein the receiving part is axially biased against a fixed stop at the shaft part in the tool feed direction via a compression spring arrangement arranged at the shaft part and can be displaced away from the fixed stop at the shaft part when the depth-control stop impacts on a workpiece against spring force of the compression spring arrangement.

2. The tool holder according to claim 1, wherein the compression spring arrangement is supported on an axially settable setting stop in the shaft part.

3. The tool holder according to claim 2, wherein the setting stop has a setting screw, which is screwed to the shaft part.

4. The tool holder according to claim 3, wherein the setting screw forms a guide extension, which engages with an axial bore in the receiving part.

5. The tool holder according to claim 4, wherein the compression spring arrangement sits on the guide extension.

6. The tool holder according to claim 1, wherein the compression spring arrangement is formed from a disk spring assembly.

7. The tool holder according to claim 1, wherein the receiving part has a guide section engaging with an axial bore in the shaft part.

8. The tool holder according to claim 7, wherein the receiving part has a cylindrical receiving section, which adjoins the guide section and which holds a clamping shaft of the machining tool.

9. The tool holder according to claim 7, wherein the receiving part is connected in a rotationally fixed manner to the shaft part via a driving pin, which protrudes diametrically from the guide section and which is guided in diametrically opposite elongated holes in the shaft part.

10. The tool holder according to claim 1, wherein the shaft part is made of a cylindrical hollow body.

11. A device for machining a workpiece, comprising a tool holder according to claim 1 and a machining tool having a depth-control stop.

12. The device according to claim 11, wherein the machining tool is a countersinking tool.
